(19) United States
(12) Patent Application Publication
(10) Pub. No.: US 2022/0312417 A1
(43) Pub. Date: Sep. 29, 2022

(54) SYSTEMS AND METHODS FOR SCG ACTIVATION AND DEACTIVATION

(71) Applicant: APPLE INC., Cupertino, CA (US)

(72) Inventors: Naveen Kumar R Palle VENKATA, San Diego, CA (US); Fangli XU, Beijing (CN); Haijing HU, Cupertino, CA (US); Lakshmi N. KAVURI, Cupertino, CA (US); Muthukumaran DHANAPAL, Cupertino, CA (US); Pengkai ZHAO, Cupertino, CA (US); Sarma V. VANGALA, Cupertino, CA (US); Thanigaivelu ELANGOVAN, Cupertino, CA (US); Wenping LOU, Cupertino, CA (US); Yuqin CHEN, Beijing (CN); Zhibin WU, Cupertino, CA (US)

(21) Appl. No.: 17/593,553

(22) PCT Filed: Oct. 22, 2020
(86) PCT No.: PCT/CN2020/122928

§ 371 Date: Sep. 20, 2021

(51) Int. Cl. H04W 72/04; H04W 76/27

(52) U.S. Cl. CPC H04W 72/0453; H04W 76/27

(57) ABSTRACT

Systems and methods provide secondary cell group (SCG) activation and deactivation. A user equipment (UE) in a wireless network may determine bandwidth part (BWP) configurations for a carrier of a primary secondary cell (PSCell) of an SCG for dual connectivity (DC). The UE may move between an SCG activation state and an SCG deactivation state based on the BWP configurations. SCG deactivation modeling may be based on a separate BWP configuration or may be modeled via a separate configuration in radio resource control (RRC) that is applicable to the BWPs in a serving cell.

### TECHNICAL FIELD

This application relates generally to wireless communication systems, including activating and deactivating a secondary cell group for a user equipment in dual connectivity.

### BACKGROUND

Wireless mobile communication technology uses various standards and protocols to transmit data between a base station and a wireless mobile device. Wireless communication system standards and protocols can include the 3rd Generation Partnership Project (3GPP) long term evolution (LTE) (e.g., 4G) or new radio (NR) (e.g., 5G); the Institute of Electrical and Electronics Engineers (IEEE) 802.16 standard, which is commonly known to industry groups as worldwide interoperability for microwave access (WiMAX); and the IEEE 802.11 standard for wireless local area networks (WLAN), which is commonly known to industry groups as Wi-Fi. In 3GPP radio access networks (RANs) in LTE systems, the base station can include a RAN Node such as a Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with a wireless communication device, known as user equipment (UE). In fifth generation (5G) wireless RANs, RAN Nodes can include a 5G Node, NR node (also referred to as a next generation Node B or g Node B (gNB)).

RANs use a radio access technology (RAT) to communicate between the RAN Node and UE. RANs can include global system for mobile communications (GSM), enhanced data rates for GSM evolution (EDGE) RAN (GERAN), Universal Terrestrial Radio Access Network (UTRAN), and/or E-UTRAN, which provide access to communication services through a core network. Each of the RANs operates according to a specific 3GPP RAT. For example, the GERAN implements GSM and/or EDGE RAT, the UTRAN implements universal mobile telecommunication system (UMTS) RAT or other 3GPP RAT, the E-UTRAN implements LTE RAT, and NG-RAN implements 5G RAT. In certain deployments, the E-UTRAN may also implement 5G RAT.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a UE in dual connectivity in accordance with various embodiments.

FIG. 2 illustrates an example method for SCG activation and/or deactivation in accordance with one embodiment.

FIG. 3 illustrates a method in accordance with one embodiment.

FIG. 4A illustrates a carrier of a PSCell in accordance with one embodiment.

FIG. 4B illustrates a carrier of an SCell in accordance with one embodiment.

FIG. 5 illustrates a method in accordance with one embodiment.

FIG. 6 illustrates a method in accordance with one embodiment.

FIG. 7 illustrates data to be transferred via an MCG and an SCG in accordance with one embodiment.

FIG. 8 illustrates an infrastructure equipment in accordance with one embodiment.

FIG. 9 illustrates a platform in accordance with one embodiment.

FIG. 10 illustrates a system in accordance with one embodiment.

FIG. 11 illustrates components in accordance with one embodiment.

### DETAILED DESCRIPTION

Embodiments disclosed herein relate to secondary cell group (SCG) activation and deactivation enhancements. One embodiment models the deactivation of an SCG via a separate bandwidth part (BWP) configuration. In addition, or in other embodiments, deactivation of an SCG may be modeled via a separate configuration in radio resource control (RRC) that is applicable to the BWPs in a serving cell.

A 5G carrier may be configured with multiple BWPs. Those skilled in the art will understand that a BWP may refer to a set of physical resource blocks (PRBs) within the carrier. The PRBs of a BWP may be contiguous. In certain systems, a UE can be configured, for example, with up to four BWPs in the uplink or four BWPs in the downlink. An additional four BWPs can be configured in a supplementary uplink. In certain implementations, only one BWP in the UL and one in the DL may be active at a given time. Thus, a UE cannot transmit a physical uplink shared channel (PUSCH) or a physical uplink control channel (PUCCH) and cannot receive a physical downlink shared channel (PDSCH) or a PDCCH outside an active BWP. BWP configuration parameters may include numerology, frequency location, bandwidth size, and control resource set (CORESET).

In certain embodiments, a network can inform the UE on whether the SCG is to be activated or is to be kept deactivated when the UE transitions from an INACTIVE mode to a CONNECTED mode. In a transition from INACTIVE to CONNECTED mode, the UE may also, for example, inform the network about the UE preference of the saved SCG configuration (e.g., a preference to deactivate the SCG at resumption or a preference to activate the SCG at resumption). As will be described in more detail below, the example embodiments may provide power and performance benefits for a UE configured with dual connectivity (DC).

Various embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network.

Therefore, the UE as described herein is used to represent any appropriate electronic component.

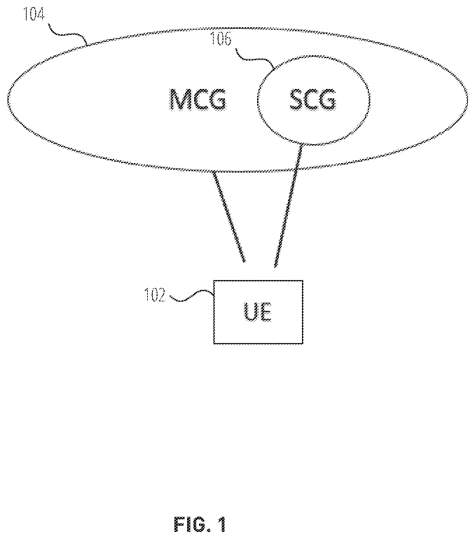

The UE may support DC to a master cell group (MCG) and an SCG. For example, FIG. 1 illustrates a UE 102 in dual connectivity with an MCG 104 and a SCG 106. The MCG 104 may include at least a master node (MN) and the SCG 106 may include at least a secondary node (SN) or secondary cell (SCell). In addition, a special cell (SpCell) may refer to a primary cell (PCell) of the MCG 104 or a primary secondary cell (PSCell) of the SCG 106. Thus, the terms “SpCell,” “MN” and “PCell” may be used interchangeably within the context of DC. Further, the terms “SpCell,” “SN” and “PSCell” may also be used interchangeably within the context of DC.

Certain systems allow the network to deactivate and/or activate the SCG 106 when the UE 102 is configured with DC. The deactivation and/or activation of the SCG 106 from the network can be, for example, via RRC signaling or via the medium access control (MAC) control element (CE) or via downlink control information (DCI).

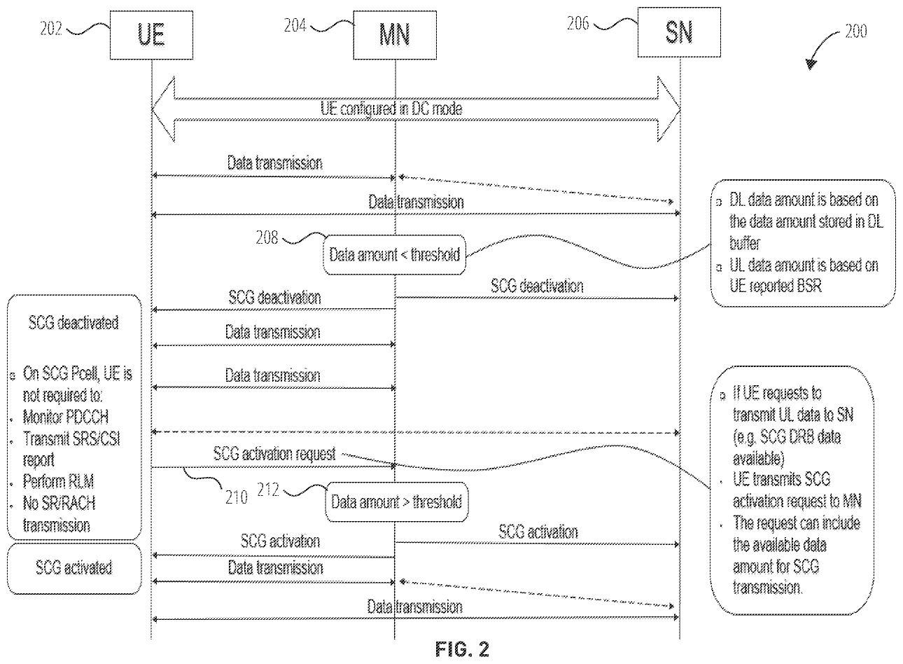

For example, FIG. 2 illustrates an example method 200 for SCG activation and/or deactivation via an MCG. In this example, a UE 202 is configured in DC mode to communicate with an MN 204 and an SN 206. In DC, data transmission occurs between the UE 202 and the MN 204 and between the UE 202 and the SN 206. Data transmission may also occur between the MN 204 and the SN 206. At block 208, the MN 204 may determine that the data amount is less than a predetermined threshold amount. The downlink (DL) data amount may be based on the data amount stored in a DL buffer. The uplink (UL) data amount may be based on a UE reported buffer status report (BSR).

Due to the data amount being less than the threshold amount, the MN 204 performs SCG deactivation (e.g., via RRC signaling) with the SN 206 and the UE 202. Thus, data transmission continues only between the UE 202 and the MN 204. With the SN 206 deactivated, on the SCG Pcell, the UE 202 is not required to monitor a physical downlink control channel (PDCCH), transmit a sounding reference signal (SRS) and/or a channel state information (CSI) report, perform radio link monitoring (RLM), or perform scheduling requests (SR) or random access channel (RACH) transmissions. If the UE 202 requests to transmit UL data to the SN 206 (e.g., SCG data radio bearer (DRB) data is available), the UE 202 transmits a SCG activation request 210 to the MN 204. The SCG activation request 210 may include the available data amount for SCG transmission. At block 212, the MN 204 may determine that the data amount indicated in the SCG activation request 210 is greater than the threshold amount. In response, the MN 204 performs SCG activation (e.g., via RRC signaling) with the SN 206 and the UE 202. After the SCG is activated, data transmission occurs between the UE 202 and the MN 204 and between the UE 202 and the SN 206. Data transmission may also occur between the MN 204 and the SN 206.

I. SCG Activation/Deactivation Configuration Modelling

In certain embodiments, configuration modelling provides the ability for the network to activate and/or deactivate the SCG of the UE via RRC signaling, via MAC CE and/or via DCI. For RRC signaling, the ability for the network to activate and/or deactivate the SCG may be via the MCG and/or via the SCG. Configuration modelling may also provide the ability of the UE to move in and out of activation and/or deactivation autonomously (e.g., based on internal events triggered), the ability of modelling the configuration of SCG activation and/or deactivation station across RRC CONNECTED and RRC INACTIVE state transitions, and/or the ability to configure the UE to perform certain actions during SCG deactivated state (e.g., perform CSI measurement and/or reporting, perform SRS, etc.).

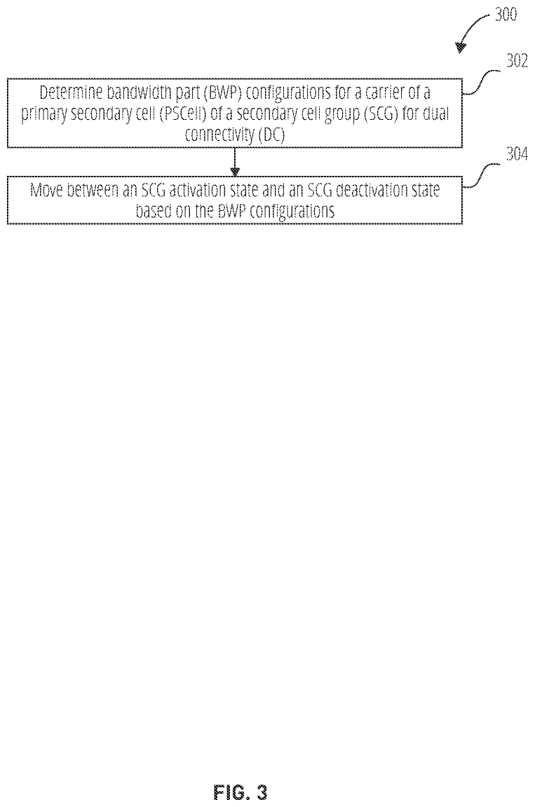

In certain embodiments, SCG activation/deactivation configuration modelling is based on one or more bandwidth part (BWP). For example, FIG. 3 is a flowchart illustrating a method 300 according to one embodiment. In block 302, the method 300 includes determining BWP configurations for a carrier of a primary secondary cell (PSCell) of a secondary cell group (SCG) for dual connectivity (DC). In block 304, the method 300 includes moving between an SCG activation state and an SCG deactivation state based on the BWP configurations.

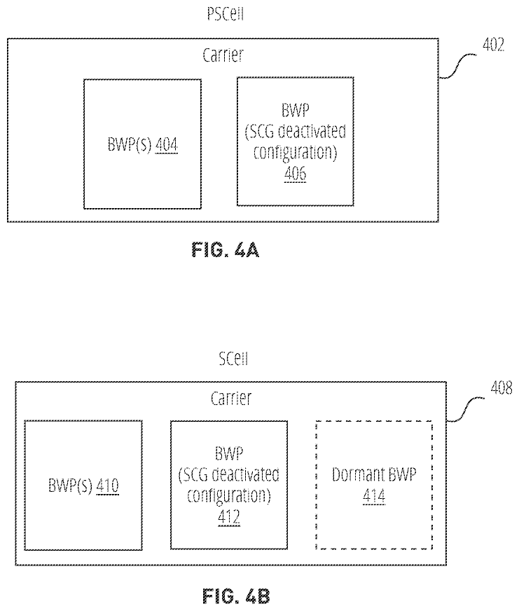

In one embodiment, deactivation of an SCG is modelled via a separate BWP configuration wherein the PSCell has an additional BWP configuration for the deactivated state. For example, FIG. 4A illustrates a carrier 402 of a PSCell comprising one or more BWP(s) 404 and an additional BWP 406 carrying an SCG deactivated configuration. The UE may be moved in and out of SCG activation and deactivation via RRC signaling where the RRC informs a BWP switch from the one or more BWP(s) 404 to the additional BWP 406 that carries the SCG deactivated configuration.

In addition, or in other embodiments, the additional BWP configuration that carries the SCG deactivated configuration can be given a BWP identifier (ID), and the network can use the MAC CE or the DCI to perform a BWP switch in the PSCell for the BWP ID, which may imply the SCG activation/deactivation transition. The MAC CE and/or the DCI can be communicated via the MCG or from the SCG (but relayed via the MCG).

In certain embodiments, SCG SCells may have additional BWP configurations to be used in SCG deactivated states. For example, FIG. 4B illustrates a carrier 408 of a SCell of the SCG comprising one or more BWP(s) 410 and an additional BWP 412 carrying an SCG deactivated configuration.

Alternatively, the network can inform the UE to use a dormant BWP configuration for SCells in SCG deactivation. For example, the carrier 408 of the SCell shown in FIG. 4B may also include a dormant BWP 414. The one or more BWP(s) 410 may be non-dormant BWP(s) that may be used for access to network services normally available via the network connection. For example, the UE may transmit and/or receive data on the (non-dormant) BWP(s) 410. The dormant BWP 414, if configured, may be used to provide power saving benefits with regard to data exchange processing at the UE. In certain embodiments, if the additional BWP 412 is not configured, the dormant BWP 414, if configured, is used. Otherwise, the SCell can be considered as deactivated.

In certain embodiments, if the SCells are configured with dormant BWPs or additional BWPs for deactivated SCG operation, the PSCell additional BWP can include the periodicities and optionally the UL resources for periodic reporting of CSI, SRS, etc.

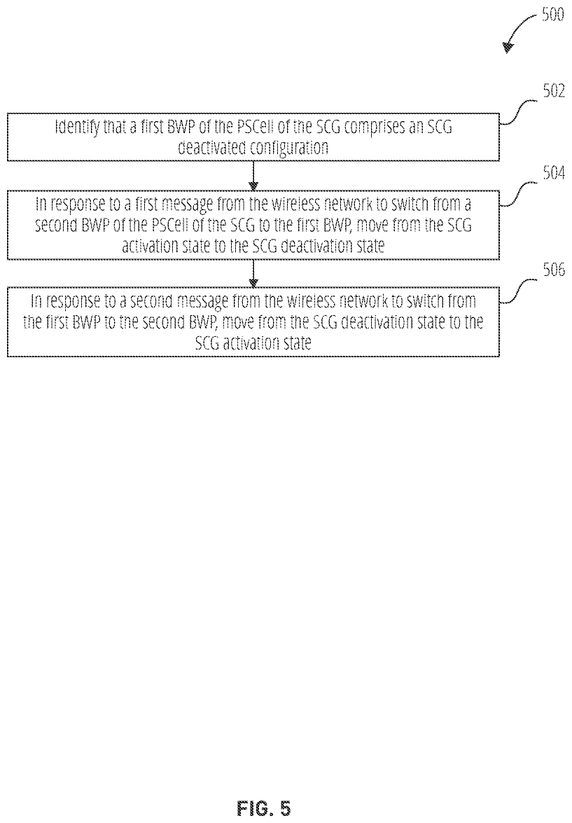

FIG. 5 is a flowchart illustrating a method 500 according to one embodiment. Continuing from the method 300 shown in FIG. 3, in block 502, the method 500 includes identifying that a first BWP of the PSCell of the SCG comprises an SCG deactivated configuration. In block 504, the method 500 includes, in response to a first message from the wireless network to switch from a second BWP of the PSCell of the SCG to the first BWP, moving from the SCG activation state to the SCG deactivation state. In block 506, the method 500 includes, in response to a second message from the wireless network to switch from the first BWP to the second BWP, moving from the SCG deactivation state to the SCG activation state.

In one embodiment of the method 500, the first message and the second message comprise radio resource control (RRC) signaling. In other embodiments, the first BWP comprising the SCG deactivated configuration is associated with a BWP identifier (ID), and the first message and the second message comprise a media access control (MAC) control element (CE) or downlink control information (DCI). The MAC CE or the DCI may be received at the UE from a master cell group (MCG) or from the SCG (relayed via the MCG).

In one embodiment, the method 500 further includes identifying that a secondary cell (SCell) of the SCG is configured with a third BWP for operation in the SCG deactivation state, and determining from the SCG deactivated configuration of the first BWP of the PSCell periodicities and/or uplink resources for periodic reporting of channel state information (SCI) or sounding reference signal (SRS) transmission. The method 500 may further include receiving an indication from the wireless network to use a dormant BWP configuration for the SCell in the SCG deactivation state. If the third BWP is not configured, the UE uses the BWP configuration for operation of the SCell in the SCG deactivation state. If neither the third BWP nor the dormant BWP configuration is configured, the UE considers the SCell to be deactivated.

Other embodiments model the deactivation of the SCG via a separate configuration in RRC that is applicable to all the BWPs (or at least a group of BWPs used by a UE) in a serving cell. In certain such embodiments, the separate configuration in RRC is applicable to all the BWPs in the serving cell. For the PSCell, the configuration may include the periodicities and optionally the UL resources for periodic reporting of CSI, SRS, etc. In the PSCell, irrespective of which BWP the UE is in, the UE may perform the SCG deactivated actions based on the separate global configuration, where the configuration is specific to each serving cell.

The UE may be moved in and out of deactivated for the entire SCG with one signaling (i.e., per serving cell configuration is not allowed in certain embodiments). The signaling can be via RRC where the UE is asked to transition for the entire SCG, or via the MAC CE or DCI wherein the MAC CE and/or the DCI can be via the MCG or from SCG (but relayed via the MCG).

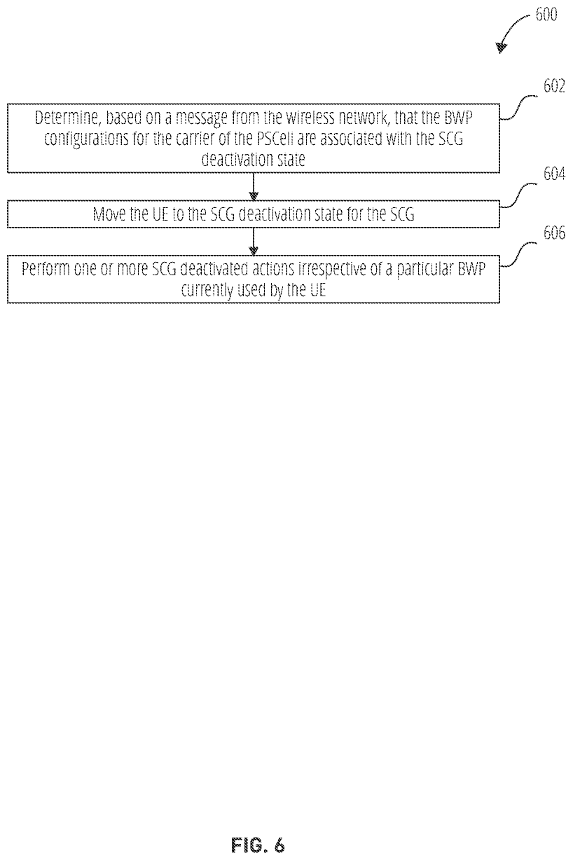

For example, FIG. 6 is a flowchart of a method 600 according to one embodiment. Continuing from the method 300 shown in FIG. 3, in block 602, the method 600 includes determining, based on a message from the wireless network, that the BWP configurations for the carrier of the PSCell are associated with the SCG deactivation state. In block 604, the method 600 includes moving the UE to the SCG deactivation state for the SCG. In block 606, the method 600 includes performing one or more SCG deactivated actions irrespective of a particular BWP currently used by the UE.

Certain embodiments of the method 600 further include determining, from the BWP configurations, at least one of periodicities and uplink resources for periodic reporting of channel state information (SCI) or sounding reference signal (SRS) transmission. The message may comprise radio resource control (RRC) signaling, a media access control (MAC) control element (CE), or downlink control information (DCI). The MAC CE or the DCI may be received from an MCG or from the SCG (relayed via the MCG).

II. Suspend/Resume with SCG Activation/Deactivation Modelling

In certain embodiments, SUSPEND/RESUME with SCG activation/deactivation modelling provides the ability of the network to move the UE to the RRC INACTIVE state while the SCG is in the deactivated state or in the activated state. Further, the modelling may provide the ability of the UE to resume from RRC INACTIVE state where the SCG was in the deactivated state (or in the activated state) and upon the resumption, the ability for the network to put the SCG in the deactivated state or the activated state. Also, embodiments provide the ability for the UE to request the network on a preference of the SCG state at transition from the RRC INACTIVE state to the RRC CONNECTED state.

In certain wireless network implementations, the UE saves the SCG configuration (and not the state of the PSCell/SCells) in suspension. At resumption, the UE deactivates all the SCells (in both MCG and SCG) and the PSCell is active.

In certain embodiments, the network may inform the UE on whether the SCG is to be activated or is to be kept deactivated when the UE transitions from the INACTIVE to CONNECTED mode. For example, the network may indicate to the UE whether the SCG can be in the deactivated state at resumption, and the corresponding PSCell actions based on the SCG deactivation configuration. If the SCG is to be kept in the deactivated state, the network may inform this via an RRCResume message. The UE then applies the SCG deactivation configuration (e.g., via the BWP model wherein the PSCell and/or the SCG SCells have an additional BWP configuration for the deactivated state, or via the per-serving cell model discussed above).

In certain embodiments, the SCG deactivation configuration may include SCell information to indicate on which of the SCells there is to be in a new state where the network expects the feedback from these SCells while the SCG is in the deactivated state. The feedback from an SCell may comprise SRS transmissions on the SCell or CSI feedback of the SCell on the PSCell or CSI feedback of the SCell using the feedback mechanisms that transfer the PSCell feedback. In certain embodiments, the SCG deactivation configuration (e.g., the BWP model or per-serving cell model discussed above) may provide this information to the UE, and the network can modify this information or activate this information in the RRC Resume message.

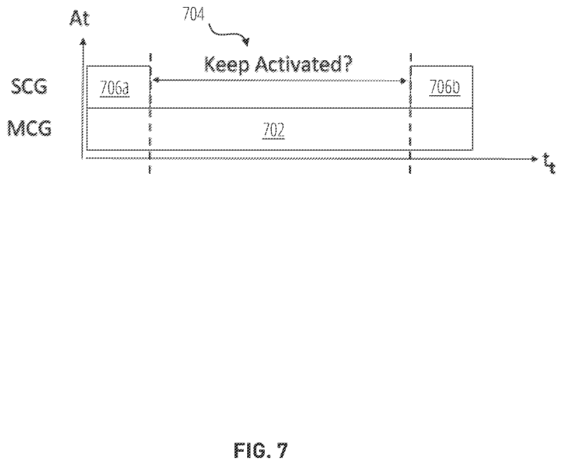

FIG. 7 illustrates data 702 to be transferred via an MCG, and data (shown as data 706a and data 706b) to be transferred via an SCG. As shown, there may be cases where a UE predicts that it does not have data to be transferred via the SCG, or it does not anticipate data in the downlink via the SCG, for a short period 704 based on the applications that the UE is using. In such cases, the network and/or the UE determines whether to keep the SCG active during the period 704 without data. Keeping the SCG active during the period 704 results in losing additional power. The UE can request the SCG to be put into discontinuous reception (DRX) mode, but the disadvantages associated with DRX operations are present (e.g., increased packet delay, etc.). If the UE resumes from the INACTIVE state for minimal transfer of data, where the UE can anticipate that the transition to the CONNECTED mode does not need the use of SCG, the SCG may still be activated by the network resulting in losing additional power.

Thus, in certain embodiments, in the transition from the INACTIVE mode to the CONNECTED mode, the UE informs the network about the UE preference of the saved SCG configuration (i.e., a preference to deactivate the SCG at resumption or a preference to activate the SCG at resumption). In certain such embodiments, the preference request is included in the RRCResume message.

In addition, or in other embodiments, while the UE is in the CONNECTED state, the UE can request the network to put the SCG into the deactivated state. For example, the UE can use a UEAssistanceInformation message to request the PCell or MCG to put SCG into deactivated state. In some embodiments, the UE can use the same message directly to the PSCell or SCG for the request using transparent forwarding via the MCG. Alternatively, the UE can send the request via signaling radio bearer 3 (SRB3) to the PSCell or SCG. In other embodiments, the UE can use a MAC CE for the request, wherein the MAC CE can be in the MCG leg. Alternatively, the MAC CE can be triggered by the UE to the SCG using the SCG MAC.

In certain embodiments, in an effort to stop the UEs from overloading the network with assistance information requests on the SCG activation and/or deactivation, the UE could wait a specified period of time during which the UE can prevent itself from repeating the same request once it has sent the assistance request. The UE can send a different assistance request (e.g., if the UE has asked for SCG deactivation, the UE can request the SCG to be activated) within the specified period of time, but cannot re-request the network for SCG deactivation when it has sent the same request earlier within the specified time. The period of time can be implicitly agreed between the UE and the network, or the network can explicitly configure the period of time during SCG configuration.

Certain embodiments provide SCG handling when the SCG is in LTE. In one embodiment, for example, while the UE is in the CONNECTED state where the SCG is actually in LTE, and where the MCG can be in LTE or in NR (e.g., LTE DC and NE-DC deployments in 3GPP), the UE may use an LTE UE assistance information RRC message to request LTE SCG deactivation and/or activation, and the corresponding timer that prohibits the UE from repeating the same request also applies (including an implicit form of the time or a network configured timer). The timer configuration (implicit or explicit) may be different between LTE SCG and NR SCG in different DC deployments.

The embodiment discussed above where the network can indicate whether the SCG can be in deactivated state at resumption may be extended to LTE SCG wherein the UE informs the NW whether it needs the LTE SCG to be activated or not at the time of UE transition to the CONNECTED mode from the INACTIVE mode (if the UE is configured with NE-DC) or transition from the RRC_SUSPEND state in LTE (if the UE is configured with LTE DC). The message from the UE may be based on the MCG RAT. For example, the UE may use an RRCResume message in NR and an RRCConnectionResume message in LTE.

The embodiment discussed above where the SCG deactivation configuration can include the SCell information on which of the SCells may be in a new state where the network expects the feedback from these SCells while the SCG is in deactivated state may also be extended wherein the network may inform which LTE SCells need to be activated or kept deactivated. The network may also indicate which LTE SCells need to be kept in a dormancy state (which is specific to LTE) as part of the SCG activation and/or deactivation.

Thus, various embodiments disclosed herein avoid or reduce UE power consumption on the SCG when there is no data transmission on the SCG.

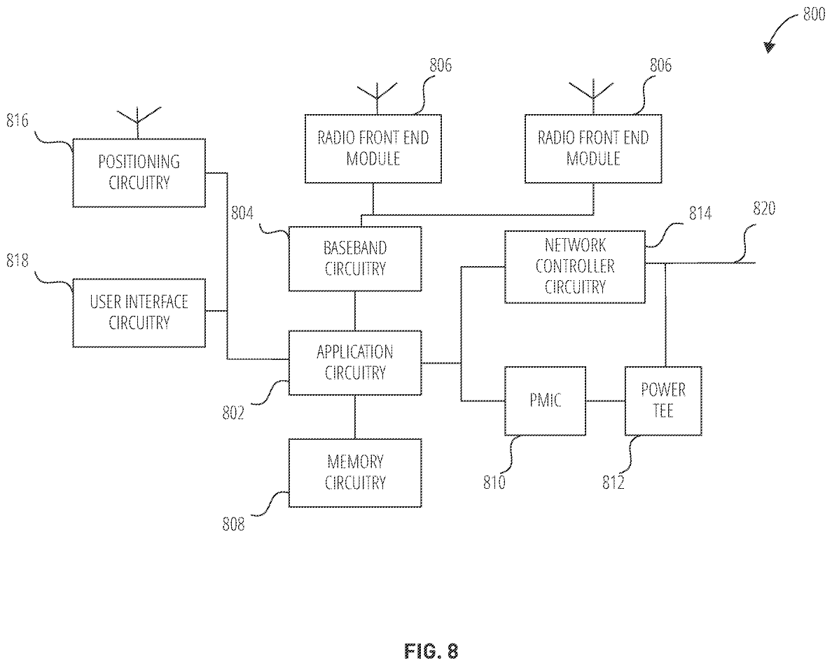

FIG. 8 illustrates an example of infrastructure equipment 800 in accordance with various embodiments. The infrastructure equipment 800 may be implemented as a base station, radio head, RAN node, AN, application server, and/or any other element/device discussed herein. In other examples, the infrastructure equipment 800 could be implemented in or by a UE.

The infrastructure equipment 800 includes application circuitry 802, baseband circuitry 804, one or more radio front end module 806 (RFEM), memory circuitry 808, power management integrated circuitry (shown as PMIC 810), power tee circuitry 812, network controller circuitry 814, network interface connector 820, satellite positioning circuitry 816, and user interface circuitry 818. In some embodiments, the device infrastructure equipment 800 may include additional elements such as, for example, memory/storage, display, camera, sensor, or input/output (I/O) interface. In other embodiments, the components described below may be included in more than one device. For example, said circuitries may be separately included in more than one device for CRAN, vBBU, or other like implementations. Application circuitry 802 includes circuitry such as, but not limited to one or more processors (or processor cores), cache memory, and one or more of low drop-out voltage regulators (LDOs), interrupt controllers, serial interfaces such as SPI, I²C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 802 may be coupled with or may include memory/storage elements and may be configured to execute instructions stored in the memory/storage to enable various applications or operating systems to run on the infrastructure equipment 800. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 802 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs, one or more PLDs, one or more ASICs, one or more microprocessors or controllers, or any suitable combination thereof. In some embodiments, the application circuitry 802 may comprise, or may be, a special-purpose processor/controller to operate according to the various embodiments herein. As examples, the processor(s) of application circuitry 802 may include one or more Intel Pentium®, Core®, or Xeon® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2@D provided by Cavium™, Inc.; a MIPS-based design from MIPS Technologies, Inc. such as MIPS Warrior P-class processors; and/or the like. In some embodiments, the infrastructure equipment 800 may not utilize application circuitry 802, and instead may include a special-purpose processor/controller to process IP data received from an EPC or 5GC, for example.

In some implementations, the application circuitry 802 may include one or more hardware accelerators, which may be microprocessors, programmable processing devices, or the like. The one or more hardware accelerators may include, for example, computer vision (CV) and/or deep learning (DL) accelerators. As examples, the programmable processing devices may be one or more a field-programmable devices (FPDs) such as field-programmable gate arrays (FPGAs) and the like; programmable logic devices(PLDs) such as complex PLDs (CPLDs), high-capacity PLDs (HCPLDs), and the like; ASICs such as structured ASICs and the like; programmable SoCs (PSoCs); and the like. In such implementations, the circuitry of application circuitry 802 may comprise logic blocks or logic fabric, and other interconnected resources that may be programmed to perform various functions, such as the procedures, methods, functions, etc. of the various embodiments discussed herein. In such embodiments, the circuitry of application circuitry 802 may include memory cells (e.g., erasable programmable read-only memory (EPROM), electrically erasable programmable read-only memory (EEPROM), flash memory, static memory (e.g., static random access memory(SRAM), anti-fuses, etc.)) used to store logic blocks, logic fabric, data, etc. in look-up-tables (LUTs) and the like. The baseband circuitry 804 may be implemented, for example, as a solder-down substrate including one or more integrated circuits, a single packaged integrated circuit soldered to a main circuit board or a multi-chip module containing two or more integrated circuits.

The user interface circuitry 818 may include one or more user interfaces designed to enable user interaction with the infrastructure equipment 800 or peripheral component interfaces designed to enable peripheral component interaction with the infrastructure equipment 800. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a nonvolatile memory port, a universal serial bus (USB) port, an audio jack, a power supply interface, etc.

The radio front end module 806 may comprise a millimeter wave (mmWave) radio front end module (RFEM) and one or more sub-mmWave radio frequency integrated circuits (RFICs). In some implementations, the one or more sub-mmWave RFICs may be physically separated from the mmWave RFEM. The RFICs may include connections to one or more antennas or antenna arrays, and the RFEM may be connected to multiple antennas. In alternative implementations, both mmWave and sub-mmWave radio functions may be implemented in the same physical radio front end module 806, which incorporates both mmWave antennas and sub-mmWave.

The memory circuitry 808 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magnetoresistive random access memory(MRAM), etc., and may incorporate the three-dimensional (3D)cross-point (XPOINT) memories from Intel® and Micron®. The memory circuitry 808 may be implemented as one or more of solder down packaged integrated circuits, socketed memory modules and plug-in memory cards.

The PMIC 810 may include voltage regulators, surge protectors, power alarm detection circuitry, and one or more backup power sources such as a battery or capacitor. The power alarm detection circuitry may detect one or more of brown out (under-voltage) and surge (over-voltage) conditions. The power tee circuitry 812 may provide for electrical power drawn from a network cable to provide both power supply and data connectivity to the infrastructure equipment 800 using a single cable.

The network controller circuitry 814 may provide connectivity to a network using a standard network interface protocol such as Ethernet, Ethernet over GRE Tunnels, Ethernet over Multiprotocol Label Switching (MPLS), or some other suitable protocol. Network connectivity may be provided to/from the infrastructure equipment 800 via network interface connector 820 using a physical connection, which may be electrical (commonly referred to as a “copper interconnect”), optical, or wireless. The network controller circuitry 814 may include one or more dedicated processors and/or FPGAs to communicate using one or more of the aforementioned protocols. In some implementations, the network controller circuitry 814 may include multiple controllers to provide connectivity to other networks using the same or different protocols.

The positioning circuitry 816 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo System, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 816 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 816 may include a Micro-Technology for Positioning, Navigation, and Timing (Micro-PNT) IC that uses a master timing clock to perform position tracking/estimation without GNSS assistance. The positioning circuitry 816 may also be part of, or interact with, the baseband circuitry 804 and/or radio front end module 806 to communicate with the nodes and components of the positioning network. The positioning circuitry 816 may also provide position data and/or time data to the application circuitry 802, which may use the data to synchronize operations with various infrastructure, or the like. The components shown by FIG. 8 may communicate with one another using interface circuitry, which may include any number of bus and/or interconnect (IX) technologies such as industry standard architecture (ISA), extended ISA (EISA), peripheral component interconnect (PCI), peripheral component interconnect extended (PCix), PCI express (PCie), or any number of other technologies. The bus/IX may be a proprietary bus, for example, used in a SoC based system. Other bus/IX systems may be included, such as an I²C interface, an SPI interface, point to point interfaces, and a power bus, among others.

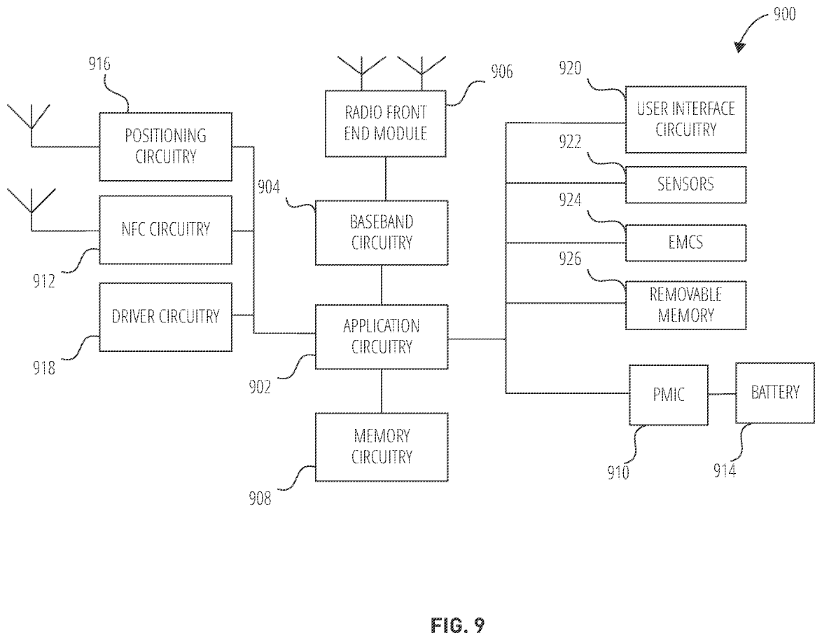

FIG. 9 illustrates an example of a platform 900 in accordance with various embodiments. In embodiments, the computer platform 900 may be suitable for use as UEs, application servers, and/or any other element/device discussed herein. The platform 900 may include any combinations of the components shown in the example. The components of platform 900 may be implemented as integrated circuits (ICs), portions thereof, discrete electronic devices, or other modules, logic, hardware, software, firmware, or a combination thereof adapted in the computer platform 900, or as components otherwise incorporated within a chassis of a larger system. The block diagram of FIG. 9 is intended to show a high level view of components of the computer platform 900. However, some of the components shown may be omitted, additional components may be present, and different arrangement of the components shown may occur in other implementations.

Application circuitry 902 includes circuitry such as, but not limited to one or more processors (or processor cores), cache memory, and one or more of LDOs, interrupt controllers, serial interfaces such as SPI, I²C or universal programmable serial interface module, RTC, timer-counters including interval and watchdog timers, general purpose IO, memory card controllers such as SD MMC or similar, USB interfaces, MIPI interfaces, and JTAG test access ports. The processors (or cores) of the application circuitry 902 may be coupled with or may include memory/storage elements and may be configured to execute instructions stored in the memory/storage to enable various applications or operating systems to run on the platform 900. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 902 may include, for example, one or more processor cores, one or more application processors, one or more GPUs, one or more RISC processors, one or more ARM processors, one or more CISC processors, one or more DSP, one or more FPGAs, one or more PLDs, one or more ASICs, one or more microprocessors or controllers, a multithreaded processor, an ultra-low voltage processor, an embedded processor, some other known processing element, or any suitable combination thereof. In some embodiments, the application circuitry 902 may comprise, or may be, a special-purpose processor/controller to operate according to the various embodiments herein.

As examples, the processor(s) of application circuitry 902 may include an Intel® Architecture Core™ based processor, such as a Quark™, an Atom™, an i3, an i5, an i7, or an MCU-class processor, or another such processor available from Intel® Corporation. The processors of the application circuitry 902 may also be one or more of Advanced Micro Devices (AMD) Ryzen® processor(s) or Accelerated Processing Units (APUs); AS-A9 processor(s) from Apple® Inc., Snapdragon™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some implementations, the application circuitry 902 may be a part of a system on a chip (SoC) in which the application circuitry 902 and other components are formed into a single integrated circuit, or a single package, such as the Edison™ or Galileo™ SoC boards from Intel® Corporation.

Additionally or alternatively, application circuitry 902 may include circuitry such as, but not limited to, one or more a field-programmable devices (FPDs) such as FPGAs and the like; programmable logic devices(PLDs) such as complex PLDs (CPLDs), high-capacity PLDs (HCPLDs), and the like; ASICs such as structured ASICs and the like; programmable SoCs (PSoCs); and the like. In such embodiments, the circuitry of application circuitry 902 may comprise logic blocks or logic fabric, and other interconnected resources that may be programmed to perform various functions, such as the procedures, methods, functions, etc. of the various embodiments discussed herein. In such embodiments, the circuitry of application circuitry 902 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in look-up tables (LUTs) and the like.

The baseband circuitry 904 may be implemented, for example, as a solder-down substrate including one or more integrated circuits, a single packaged integrated circuit soldered to a main circuit board or a multi-chip module containing two or more integrated circuits.

The radio front end module 906 may comprise a millimeter wave (mmWave) radio front end module (RFEM) and one or more sub-mmWave radio frequency integrated circuits (RFICs). In some implementations, the one or more sub-mmWave RFICs may be physically separated from the mmWave RFEM. The RFICs may include connections to one or more antennas or antenna arrays, and the RFEM may be connected to multiple antennas. In alternative implementations, both mmWave and sub-mmWave radio functions may be implemented in the same physical radio front end module 906, which incorporates both mmWave antennas and sub-mmWave.

The memory circuitry 908 may include any number and type of memory devices used to provide for a given amount of system memory. As examples, the memory circuitry 908 may include one or more of volatile memory including random access memory (RAM), dynamic RAM (DRAM) and/or synchronous dynamic RAM (SD RAM), and nonvolatile memory (NVM) including high-speed electrically erasable memory (commonly referred to as Flash memory), phase change random access memory (PRAM), magnetoresistive random access memory (MRAM), etc. The memory circuitry 908 may be developed in accordance with a Joint Electron Devices Engineering Council (JEDEC) low power double data rate (LPDDR)-based design, such as LPDDR2, LPDDR3, LPDDR4, or the like. Memory circuitry 908 may be implemented as one or more of solder down packaged integrated circuits, single die package (SDP), dual die package (DDP) or quad die package (Q17P), socketed memory modules, dual inline memory modules (DIMMs) including microDIMMs or MiniDIMMs, and/or soldered onto a motherboard via a ball grid array (BGA). In low power implementations, the memory circuitry 908 maybe on-die memory or registers associated with the application circuitry 902. To provide for persistent storage of information such as data, applications, operating systems and so forth, memory circuitry 908 may include one or more mass storage devices, which may include, inter alia, a solid state disk drive (SSDD), hard disk drive(HDD), a microHDD, resistance change memories, phase change memories, holographic memories, or chemical memories, among others. For example, the computer platform 900 may incorporate the three-dimensional (3D) cross-point (XPOINT) memories from Intel® and Micron®.

The removable memory 926 may include devices, circuitry, enclosures/housings, ports or receptacles, etc. used to couple portable data storage devices with the platform 900. These portable data storage devices may be used for mass storage purposes, and may include, for example, flash memory cards (e.g., Secure Digital (SD) cards, microSD cards, xD picture cards, and the like), and USB flash drives, optical discs, external HDDs, and the like.

The platform 900 may also include interface circuitry (not shown) that is used to connect external devices with the platform 900. The external devices connected to the platform 900 via the interface circuitry include sensors 922 and electro-mechanical components (shown as EMCs 924), as well as removable memory devices coupled to removable memory 926.

The sensors 922 include devices, modules, or subsystems whose purpose is to detect events or changes in its environment and send the information (sensor data) about the detected events to some other a device, module, subsystem, etc. Examples of such sensors include, inter alia, inertia measurement units (IMUs) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors); pressure sensors; barometric pressure sensors; gravimeters; altimeters; image capture devices (e.g., cameras or lensless apertures); light detection and ranging (LiDAR) sensors; proximity sensors (e.g., infrared radiation detector and the like), depth sensors, ambient light sensors, ultrasonic transceivers; microphones or other like audio capture devices; etc.

EMCs 924 include devices, modules, or subsystems whose purpose is to enable platform 900 to change its state, position, and/or orientation, or move or control a mechanism or (sub)system. Additionally, EMCs 924 may be configured to generate and send messages/signaling to other components of the platform 900 to indicate a current state of the EMCs 924. Examples of the EMCs 924 include one or more power switches, relays including electromechanical relays (EMRs) and/or solid state relays (SSRs), actuators (e.g., valve actuators, etc.), an audible sound generator, a visual warning device, motors (e.g., DC motors, stepper motors, etc.), wheels, thrusters, propellers, claws, clamps, hooks, and/or other like electro-mechanical components. In embodiments, platform 900 is configured to operate one or more EMCs 924 based on one or more captured events and/or instructions or control signals received from a service provider and/or various clients. In some implementations, the interface circuitry may connect the platform 900 with positioning circuitry 916. The positioning circuitry 916 includes circuitry to receive and decode signals transmitted/broadcasted by a positioning network of a GNSS. Examples of navigation satellite constellations (or GNSS)include United States' GPS, Russia's GLONASS, the European Union's Galileo system, China's BeiDou Navigation Satellite System, a regional navigation system or GNSS augmentation system(e.g., NAVIC), Japan's QZSS, France's DORIS, etc.), or the like. The positioning circuitry 916 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 916 may include a Micro-PNT IC that uses a master timing clock to perform position tracking/estimation without GNSS assistance. The positioning circuitry 916 may also be part of, or interact with, the baseband circuitry 904 and/or radio front end module 906 to communicate with the nodes and components of the positioning network. The positioning circuitry 916 may also provide position data and/or time data to the application circuitry 902, which may use the data to synchronize operations with various infrastructure (e.g., radio base stations), for turn-by-turn navigation applications, or the like.

In some implementations, the interface circuitry may connect the platform 900 with Near-Field Communication circuitry (shown as NFC circuitry 912). The NFC circuitry 912 is configured to provide contactless, short-range communications based on radio frequency identification (RFID) standards, wherein magnetic field induction is used to enable communication between NFC circuitry 912 and NFC-enabled devices external to the platform 900 (e.g., an “NFC touchpoint”). NFC circuitry 912 comprises an NFC controller coupled with an antenna element and a processor coupled with the NFC controller. The NFC controller may be a chip/IC providing NFC functionalities to the NFC circuitry 912 by executing NFC controller firmware and an NFC stack. The NFC stack may be executed by the processor to control the NFC controller, and the NFC controller firmware may be executed by the NFC controller to control the antenna element to emit short-range RF signals. The RF signals may power a passive NFC tag (e.g., a microchip embedded in a sticker or wristband) to transmit stored data to the NFC circuitry 912, or initiate data transfer between the NFC circuitry 912 and another active NFC device (e.g., a smartphone or an NFC-enabled POS terminal) that is proximate to the platform 900.

The driver circuitry 918 may include software and hardware elements that operate to control particular devices that are embedded in the platform 900, attached to the platform 900, or otherwise communicatively coupled with the platform 900. The driver circuitry 918 may include individual drivers allowing other components of the platform 900 to interact with or control various input/output (I/O) devices that may be present within, or connected to, the platform 900. For example, driver circuitry 918 may include a display driver to control and allow access to a display device, a touchscreen driver to control and allow access to a touchscreen interface of the platform 900, sensor drivers to obtain sensor readings of sensors 922 and control and allow access to sensors 922, EMC drivers to obtain actuator positions of the EMCs 924 and/or control and allow access to the EMCs 924, a camera driver to control and allow access to an embedded image capture device, audio drivers to control and allow access to one or more audio devices.

The power management integrated circuitry (shown as PMIC 910) (also referred to as “power management circuitry”) may manage power provided to various components of the platform 900. In particular, with respect to the baseband circuitry 904, the PMIC 910 may control power-source selection, voltage scaling, battery charging, or DC-to-DC conversion. The PMIC 910 may often be included when the platform 900 is capable of being powered by a battery 914, for example, when the device is included in a UE.

In some embodiments, the PMIC 910 may control, or otherwise be part of, various power saving mechanisms of the platform 900. For example, if the platform 900 is in an RRC_Connected state, where it is still connected to the RAN node as it expects to receive traffic shortly, then it may enter a state known as Discontinuous Reception Mode (DRX) after a period of inactivity. During this state, the platform 900 may power down for brief intervals of time and thus save power. If there is no data traffic activity for an extended period of time, then the platform 900 may transition off to an RRC_Idle state, where it disconnects from the network and does not perform operations such as channel quality feedback, handover, etc. The platform 900 goes into a very low power state and it performs paging where again it periodically wakes up to listen to the network and then powers down again. The platform 900 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 914 may power the platform 900, although in some examples the platform 900 may be mounted deployed in a fixed location, and may have a power supply coupled to an electrical grid. The battery 914 may be a lithium ion battery, a metal-air battery, such as a zinc-air battery, an aluminum-air battery, a lithium-air battery, and the like. In some implementations, such as in V2X applications, the battery 914 may be a typical lead-acid automotive battery.

In some implementations, the battery 914 may be a “smart battery,” which includes or is coupled with a Battery Management System (BMS) or battery monitoring integrated circuitry. The BMS may be included in the platform 900 to track the state of charge (SoCh) of the battery 914. The BMS may be used to monitor other parameters of the battery 914 to provide failure predictions, such as the state of health (SoH) and the state of function (SoF) of the battery 914. The BMS may communicate the information of the battery 914 to the application circuitry 902 or other components of the platform 900. The BMS may also include an analog-to-digital (ADC) convertor that allows the application circuitry 902 to directly monitor the voltage of the battery 914 or the current flow from the battery 914. The battery parameters may be used to determine actions that the platform 900 may perform, such as transmission frequency, network operation, sensing frequency, and the like.

A power block, or other power supply coupled to an electrical grid may be coupled with the BMS to charge the battery 914. In some examples, the power block may be replaced with a wireless power receiver to obtain the power wirelessly, for example, through a loop antenna in the computer platform 900. In these examples, a wireless battery charging circuit may be included in the BMS. The specific charging circuits chosen may depend on the size of the battery 914, and thus, the current required. The charging may be performed using the Airfuel standard promulgated by the Airfuel Alliance, the Qi wireless charging standard promulgated by the Wireless Power Consortium, or the Rezence charging standard promulgated by the Alliance for Wireless Power, among others.

User interface circuitry 920 includes various input/output (I/O) devices present within, or connected to, the platform 900, and includes one or more user interfaces designed to enable user interaction with the platform 900 and/or peripheral component interfaces designed to enable peripheral component interaction with the platform 900. The user interface circuitry 920 includes input device circuitry and output device circuitry. Input device circuitry includes any physical or virtual means for accepting an input including, inter alia, one or more physical or virtual buttons (e.g., a reset button), a physical keyboard, keypad, mouse, touchpad, touchscreen, microphones, scanner, headset, and/or the like. The output device circuitry includes any physical or virtual means for showing information or otherwise conveying information, such as sensor readings, actuator position(s), or other like information. Output device circuitry may include any number and/or combinations of audio or visual display, including, inter alia, one or more simple visual outputs/indicators such as binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the platform 900. The output device circuitry may also include speakers or other audio emitting devices, printer(s), and/or the like. In some embodiments, the sensors 922 may be used as the input device circuitry (e.g., an image capture device, motion capture device, or the like) and one or more EMCs may be used as the output device circuitry (e.g., an actuator to provide haptic feedback or the like). In another example, NFC circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, etc.

Although not shown, the components of platform 900 may communicate with one another using a suitable bus or interconnect (IX) technology, which may include any number of technologies, including ISA, EISA, PCI, PCix, PCie, a Time-Trigger Protocol (TTP) system, a FlexRay system, or any number of other technologies. The bus/IX may be a proprietary bus/IX, for example, used in a SoC based system. Other bus/IX systems may be included, such as an I²C interface, an SPI interface, point-to-point interfaces, and a power bus, among others.

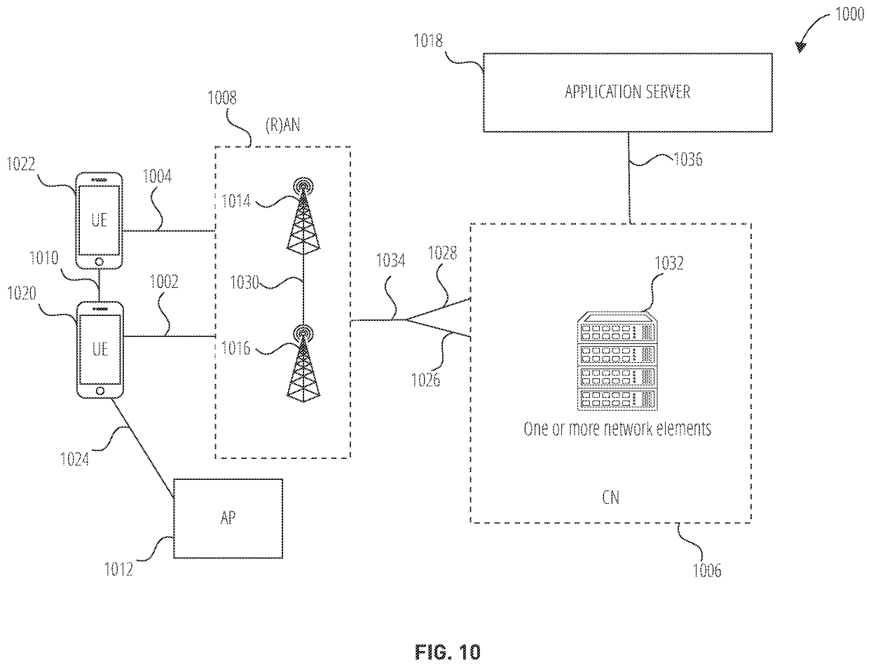

FIG. 10 illustrates an example architecture of a system 1000 of a network, in accordance with various embodiments. The following description is provided for an example system 1000 that operates in conjunction with the LTE system standards and 5G or NR system standards as provided by 3GPP technical specifications. However, the example embodiments are not limited in this regard and the described embodiments may apply to other networks that benefit from the principles described herein, such as future 3GPP systems (e.g., Sixth Generation (6G)) systems, IEEE 802.16 protocols (e.g., WMAN, WiMAX, etc.), or the like.

As shown by FIG. 10, the system 1000 includes UE 1022 and UE 1020. In this example, the UE 1022 and the UE 1020 are illustrated as smartphones (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, MTC devices, M2M, IoT devices, and/or the like.

In some embodiments, the UE 1022 and/or the UE 1020 may be IoT UEs, which may comprise a network access layer designed for low power IoT applications utilizing short-lived UE connections. An IoT UE can utilize technologies such as M2M or MTC for exchanging data with an MTC server or device via a PLMN, ProSe or D2D communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UE 1022 and UE 1020 may be configured to connect, for example, communicatively couple, with an access node or radio access node (shown as (R)AN 1008). In embodiments, the (R)AN 1008 may be an NG RAN or a SG RAN, an E-UTRAN, or a legacy RAN, such as a UTRAN or GERAN. As used herein, the term “NG RAN” or the like may refer to a (R)AN 1008 that operates in an NR or SG system, and the term “E-UTRAN” or the like may refer to a (R)AN 1008 that operates in an LTE or 4G system. The UE 1022 and UE 1020 utilize connections (or channels) (shown as connection 1004 and connection 1002, respectively), each of which comprises a physical communications interface or layer (discussed in further detail below).

In this example, the connection 1004 and connection 1002 are air interfaces to enable communicative coupling, and can be consistent with cellular communications protocols, such as a GSM protocol, a CDMA network protocol, a PTT protocol, a POC protocol, a UMTS protocol, a 3GPP LTE protocol, a SG protocol, a NR protocol, and/or any of the other communications protocols discussed herein. In embodiments, the UE 1022 and UE 1020 may directly exchange communication data via a ProSe interface 1010. The ProSe interface 1010 may alternatively be referred to as a sidelink (SL) interface 110 and may comprise one or more logical channels, including but not limited to a PSCCH, a PSSCH, a PSDCH, and a PSBCH.

The UE 1020 is shown to be configured to access an AP 1012 (also referred to as “WLAN node,” “WLAN,” “WLAN Termination,” “WT” or the like) via connection 1024. The connection 1024 can comprise a local wireless connection, such as a connection consistent with any IEEE 802.11 protocol, wherein the AP 1012 would comprise a wireless fidelity (Wi-Fi®) router. In this example, the AP 1012 may be connected to the Internet without connecting to the core network of the wireless system (described in further detail below). In various embodiments, the UE 1020, (R)AN 1008, and AP 1012 may be configured to utilize LWA operation and/or LWIP operation. The LWA operation may involve the UE 1020 in RRC_CONNECTED being configured by the RAN node 1014 or the RAN node 1016 to utilize radio resources of LTE and WLAN. LWIP operation may involve the UE 1020 using WLAN radio resources (e.g., connection 1024) via IPsec protocol tunneling to authenticate and encrypt packets (e.g., IP packets) sent over the connection 1024. IPsec tunneling may include encapsulating the entirety of original IP packets and adding a new packet header, thereby protecting the original header of the IP packets.

The (R)AN 1008 can include one or more AN nodes, such as RAN node 1014 and RAN node 1016, that enable the connection 1004 and connection 1002. As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs TRxPs or TRPs, and so forth, and can comprise ground stations (e.g., terrestrial access points) or satellite stations providing coverage within a geographic area (e.g., a cell). As used herein, the term “NG RAN node” or the like may refer to a RAN node that operates in an NR or SG system (for example, a gNB), and the term “E-UTRAN node” or the like may refer to a RAN node that operates in an LTE or 4G system 1000 (e.g., an eNB). According to various embodiments, the RAN node 1014 or RAN node 1016 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the RAN node 1014 or RAN node 1016 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by individual RAN nodes (e.g., RAN node 1014 or RAN node 1016); a MAC/PHY split wherein RRC, PDCP, RLC, and MAC layers are operated by the CRAN/vBBUP and the PHY layer is operated by individual RAN nodes (e.g., RAN node 1014 or RAN node 1016); or a “lower PHY” split wherein RRC, PDCP, RLC, MAC layers and upper portions of the PHY layer are operated by the CRAN/vBBUP and lower portions of the PHY layer are operated by individual RAN nodes. This virtualized framework allows the freed-up processor cores of the RAN node 1014 or RAN node 1016 to perform other virtualized applications. In some implementations, an individual RAN node may represent individual gNB-DUs that are connected to a gNB-CU via individual F1 interfaces (not shown by FIG. 10). In these implementations, the gNB-DUs may include one or more remote radio heads or RFEMs, and the gNB-CU may be operated by a server that is located in the (R)AN 1008 (not shown) or by a server pool in a similar manner as the CRAN/vBBUP. Additionally, or alternatively, one or more of the RAN node 1014 or RAN node 1016 may be next generation eNBs (ng-eNBs), which are RAN nodes that provide E-UTRA user plane and control plane protocol terminations toward the UE 1022 and UE 1020, and are connected to an SGC via an NG interface (discussed infra). In V2X scenarios one or more of the RAN node 1014 or RAN node 1016 may be or act as RSUs.

The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (vUEs). The RSU may also include internal data storage circuitry to store intersection map geometry, traffic statistics, media, as well as applications/software to sense and control ongoing vehicular and pedestrian traffic. The RSU may operate on the 5.9 GHz Direct Short Range Communications (DSRC) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communication. The computing device(s) and some or all of the radio frequency circuitry of the RSU may be packaged in a weatherproof enclosure suitable for outdoor installation, and may include a network interface controller to provide a wired connection (e.g., Ethernet) to a traffic signal controller and/or a backhaul network.

The RAN node 1014 and/or the RAN node 1016 can terminate the air interface protocol and can be the first point of contact for the UE 1022 and UE 1020. In some embodiments, the RAN node 1014 and/or the RAN node 1016 can fulfill various logical functions for the (R)AN 1008 including, but not limited to, radio network controller (RNC) functions such as radio bearer management, uplink and downlink dynamic radio resource management and data packet scheduling, and mobility management.

In embodiments, the UE 1022 and UE 1020 can be configured to communicate using OFDM communication signals with each other or with the RAN node 1014 and/or the RAN node 1016 over a multicarrier communication channel in accordance with various communication techniques, such as, but not limited to, an OFDMA communication technique (e.g., for downlink communications) or a SC-FDMA communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from the RAN node 1014 and/or the RAN node 1016 to the UE 1022 and UE 1020, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

According to various embodiments, the UE 1022 and UE 1020 and the RAN node 1014 and/or the RAN node 1016 communicate data (for example, transmit and receive) over a licensed medium (also referred to as the “licensed spectrum” and/or the “licensed band”) and an unlicensed shared medium (also referred to as the “unlicensed spectrum” and/or the “unlicensed band”). The licensed spectrum may include channels that operate in the frequency range of approximately 400 MHz to approximately 3.8 GHz, whereas the unlicensed spectrum may include the 5 GHz band.

To operate in the unlicensed spectrum, the UE 1022 and UE 1020 and the RAN node 1014 or RAN node 1016 may operate using LAA, eLAA, and/or feLAA mechanisms. In these implementations, the UE 1022 and UE 1020 and the RAN node 1014 or RAN node 1016 may perform one or more known medium-sensing operations and/or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

LBT is a mechanism whereby equipment (for example, UE 1022 and UE 1020, RAN node 1014 or RAN node 1016, etc.) senses a medium (for example, a channel or carrier frequency) and transmits when the medium is sensed to be idle (or when a specific channel in the medium is sensed to be unoccupied). The medium sensing operation may include CCA, which utilizes at least ED to determine the presence or absence of other signals on a channel in order to determine if a channel is occupied or clear. This LBT mechanism allows cellular/LAA networks to coexist with incumbent systems in the unlicensed spectrum and with other LAA networks. ED may include sensing RF energy across an intended transmission band for a period of time and comparing the sensed RF energy to a predefined or configured threshold.

Typically, the incumbent systems in the 5 GHz band are WLANs based on IEEE 802.11 technologies. WLAN employs a contention-based channel access mechanism, called CSMA/CA Here, when a WLAN node (e.g., a mobile station (MS) such as UE 1022, AP 1012, or the like) intends to transmit, the WLAN node may first perform CCA before transmission. Additionally, a backoff mechanism is used to avoid collisions in situations where more than one WLAN node senses the channel as idle and transmits at the same time. The backoff mechanism may be a counter that is drawn randomly within the CWS, which is increased exponentially upon the occurrence of collision and reset to a minimum value when the transmission succeeds. The LBT mechanism designed for LAA is somewhat similar to the CSMA/CA of WLAN. In some implementations, the LBT procedure for DL or UL transmission bursts including PDSCH or PUSCH transmissions, respectively, may have an LAA contention window that is variable in length between X and Y ECCA slots, where X and Y are minimum and maximum values for the CWSs for LAA. In one example, the minimum CWS for an LAA transmission may be 9 microseconds (μs); however, the size of the CWS and a MCOT (for example, a transmission burst) may be based on governmental regulatory requirements.

The LAA mechanisms are built upon CA technologies of LTE-Advanced systems. In CA, each aggregated carrier is referred to as a CC. A CC may have a bandwidth of 1.4, 3, 5, 10, 15 or 20 MHz and a maximum of five CCs can be aggregated, and therefore, a maximum aggregated bandwidth is 100 MHz. In FDD systems, the number of aggregated carriers can be different for DL and UL, where the number of UL CCs is equal to or lower than the number of DL component carriers. In some cases, individual CCs can have a different bandwidth than other CCs. In TDD systems, the number of CCs as well as the bandwidths of each CC is usually the same for DL and UL.

CA also comprises individual serving cells to provide individual CCs. The coverage of the serving cells may differ, for example, because CCs on different frequency bands will experience different pathloss. A primary service cell or PCell may provide a PCC for both UL and DL, and may handle RRC and NAS related activities. The other serving cells are referred to as SCells, and each SCell may provide an individual SCC for both UL and DL. The SCCs may be added and removed as required, while changing the PCC may require the UE 1022 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe.

The PDSCH carries user data and higher-layer signaling to the UE 1022 and UE 1020. The PDCCH carries information about the transport format and resource allocations related to the PDSCH channel, among other things. It may also inform the UE 1022 and UE 1020 about the transport format, resource allocation, and HARQ information related to the uplink shared channel. Typically, downlink scheduling (assigning control and shared channel resource blocks to the UE 1020 within a cell) may be performed at any of the RAN node 1014 or RAN node 1016 based on channel quality information fed back from any of the UE 1022 and UE 1020. The downlink resource assignment information may be sent on the PDCCH used for (e.g., assigned to) each of the UE 1022 and UE 1020.

The PDCCH uses CCEs to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as REGs. Four Quadrature Phase Shift Keying (QPSK) symbols may be mapped to each REG. The PDCCH can be transmitted using one or more CCEs, depending on the size of the DCI and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an EPDCCH that uses PDSCH resources for control information transmission. The EPDCCH may be transmitted using one or more ECCEs. Similar to above, each ECCE may correspond to nine sets of four physical resource elements known as an EREGs. An ECCE may have other numbers of EREGs in some situations.

The RAN node 1014 or RAN node 1016 may be configured to communicate with one another via interface 1030. In embodiments where the system 1000 is an LTE system (e.g., when CN 1006 is an EPC), the interface 1030 may be an X2 interface. The X2 interface may be defined between two or more RAN nodes (e.g., two or more eNBs and the like) that connect to an EPC, and/or between two eNBs connecting to the EPC. In some implementations, the X2 interface may include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a MeNB to an SeNB; information about successful in sequence delivery of PDCP PDUs to a UE 1022 from an SeNB for user data; information of PDCP PDUs that were not delivered to a UE 1022; information about a current minimum desired buffer size at the Se NB for transmitting to the UE user data; and the like. The X2-C may provide intra-LTE access mobility functionality, including context transfers from source to target eNBs, user plane transport control, etc.; load management functionality; as well as inter-cell interference coordination functionality.

In embodiments where the system 1000 is a SG or NR system (e.g., when CN 1006 is an SGC), the interface 1030 may be an Xn interface. The Xn interface is defined between two or more RAN nodes (e.g., two or more gNBs and the like) that connect to SGC, between a RAN node 1014 (e.g., a gNB) connecting to SGC and an eNB, and/or between two eNBs connecting to 5GC (e.g., CN 1006). In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 1022 in a connected mode (e.g., CM-CONNECTED) including functionality to manage the UE mobility for connected mode between one or more RAN node 1014 or RAN node 1016. The mobility support may include context transfer from an old (source) serving RAN node 1014 to new (target) serving RAN node 1016; and control of user plane tunnels between old (source) serving RAN node 1014 to new (target) serving RAN node 1016. A protocol stack of the Xn-U may include a transport network layer built on Internet Protocol (IP) transport layer, and a GTP-U layer on top of a UDP and/or IP layer(s) to carry user plane PDUs. The Xn-C protocol stack may include an application layer signaling protocol (referred to as Xn Application Protocol (Xn-AP)) and a transport network layer that is built on SCTP. The SCTP may be on top of an IP layer, and may provide the guaranteed delivery of application layer messages. In the transport IP layer, point-to-point transmission is used to deliver the signaling PDUs. In other implementations, the Xn-U protocol stack and/or the Xn-C protocol stack may be same or similar to the user plane and/or control plane protocol stack(s) shown and described herein.

The (R)AN 1008 is shown to be communicatively coupled to a core network-in this embodiment, CN 1006. The CN 1006 may comprise one or more network elements 1032, which are configured to offer various data and telecommunications services to customers/subscribers (e.g., users of UE 1022 and UE 1020) who are connected to the CN 1006 via the (R)AN 1008. The components of the CN 1006 may be implemented in one physical node or separate physical nodes including components to read and execute instructions from a machine-readable or computer-readable medium (e.g., a non-transitory machine-readable storage medium). In some embodiments, NFV may be utilized to virtualize any or all of the above-described network node functions via executable instructions stored in one or more computer-readable storage mediums (described in further detail below). A logical instantiation of the CN 1006 may be referred to as a network slice, and a logical instantiation of a portion of the CN 1006 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

Generally, an application server 1018 may be an element offering applications that use IP bearer resources with the core network (e.g., UMTS PS domain, LTE PS data services, etc.). The application server 1018 can also be configured to support one or more communication services (e.g., VoIP sessions, PTT sessions, group communication sessions, social networking services, etc.) for the UE 1022 and UE 1020 via the EPC. The application server 1018 may communicate with the CN 1006 through an IP communications interface 1036.

In embodiments, the CN 1006 may be an SGC, and the (R)AN 116 may be connected with the CN 1006 via an NG interface 1034. In embodiments, the NG interface 1034 may be split into two parts, an NG user plane (NG-U) interface 1026, which carries traffic data between the RAN node 1014 or RAN node 1016 and a UPF, and the S1 control plane (NG-C) interface 1028, which is a signaling interface between the RAN node 1014 or RAN node 1016 and AMFs.

In embodiments, the CN 1006 may be a SG CN, while in other embodiments, the CN 1006 may be an EPC). Where CN 1006 is an EPC, the (R)AN 116 may be connected with the CN 1006 via an S1 interface 1034. In embodiments, the S1 interface 1034 may be split into two parts, an S1 user plane (S1-U) interface 1026, which carries traffic data between the RAN node 1014 or RAN node 1016 and the S-GW, and the S1-MME interface 1028, which is a signaling interface between the RAN node 1014 or RAN node 1016 and MMEs.

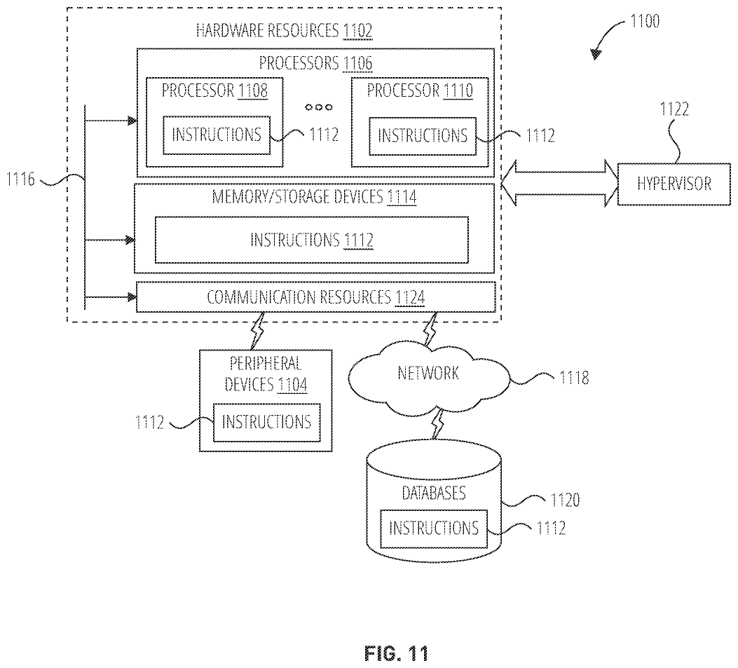

FIG. 11 is a block diagram illustrating components 1100, according to some example embodiments, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1102 including one or more processors 1106 (or processor cores), one or more memory/storage devices 1114, and one or more communication resources 1124, each of which may be communicatively coupled via a bus 1116. For embodiments where node virtualization (e.g., NFV) is utilized, a hypervisor 1122 may be executed to provide an execution environment for one or more network slices/sub-slices to utilize the hardware resources 1102.

The processors 1106 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1108 and a processor 1110.

The memory/storage devices 1114 may include main memory, disk storage, or any suitable combination thereof. The memory/storage devices 1114 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1124 may include interconnection or network interface components or other suitable devices to communicate with one or more peripheral devices 1104 or one or more databases 1120 via a network 1118. For example, the communication resources 1124 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1112 may comprise software, a program, an application, an applet, an app, or other executable code for causing at least any of the processors 1106 to perform any one or more of the methodologies discussed herein. The instructions 1112 may reside, completely or partially, within at least one of the processors 1106 (e.g., within the processor's cache memory), the memory/storage devices 1114, or any suitable combination thereof. Furthermore, any portion of the instructions 1112 may be transferred to the hardware resources 1102 from any combination of the peripheral devices 1104 or the databases 1120. Accordingly, the memory of the processors 1106, the memory/storage devices 1114, the peripheral devices 1104, and the databases 1120 are examples of computer-readable and machine-readable media.

For one or more embodiments, at least one of the components set forth in one or more of the preceding figures may be configured to perform one or more operations, techniques, processes, and/or methods as set forth in the Example Section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Example Section

The following examples pertain to further embodiments.

Example 1 is a method for a user equipment (UE) in a wireless network. The method includes determining bandwidth part (BWP) configurations for a carrier of a primary secondary cell (PSCell) of a secondary cell group (SCG) for dual connectivity (DC), and moving between an SCG activation state and an SCG deactivation state based on the BWP configurations.

Example 2 includes the method of Example 1, further comprising: identifying that a first BWP of the PSCell of the SCG comprises an SCG deactivated configuration; in response to a first message from the wireless network to switch from a second BWP of the PSCell of the SCG to the first BWP, moving from the SCG activation state to the SCG deactivation state; and in response to a second message from the wireless network to switch from the first BWP to the second BWP, moving from the SCG deactivation state to the SCG activation state.

Example 3 includes the method of Example 2, wherein the first message and the second message comprise radio resource control (RRC) signaling.

Example 4 includes the method of Example 2, wherein the first BWP comprising the SCG deactivated configuration is associated with a BWP identifier (ID), and wherein the first message and the second message comprise a media access control (MAC) control element (CE) or downlink control information (DCI).

Example 5 includes the method of Example 4, wherein the MAC CE or the DCI is received from a master cell group (MCG).

Example 6 includes the method of Example 4, wherein the MAC CE or the DCI is from the SCG and relayed via the MCG.

Example 7 includes the method of Example 2, further comprising: identifying that a secondary cell (SCell) of the SCG is configured with a third BWP for operation in the SCG deactivation state; and determining, from the SCG deactivated configuration of the first BWP of the PSCell, at least one of periodicities and uplink resources for periodic reporting of channel state information (SCI) or sounding reference signal (SRS) transmission.

Example 8 includes the method of Example 7, further comprising: receiving an indication from the wireless network to use a dormant BWP configuration for the SCell in the SCG deactivation state; if the third BWP is not configured, using the BWP configuration for operation of the SCell in the SCG deactivation state; and if neither the third BWP nor the dormant BWP configuration is configured, consider the SCell to be deactivated.

Example 9 includes the method of Example 1, further comprising: determining, based on a message from the wireless network, that the BWP configurations for the carrier of the PSCell are associated with the SCG deactivation state; moving the UE to the SCG deactivation state for the SCG; and performing one or more SCG deactivated actions irrespective of a particular BWP currently used by the UE.

Example 10 includes the method of Example 9, further comprising determining, from the BWP configurations, at least one of periodicities and uplink resources for periodic reporting of channel state information (SCI) or sounding reference signal (SRS) transmission.

Example 11 includes the method of Example 9, wherein the message comprises radio resource control (RRC) signaling.

Example 12 includes the method of Example 9, wherein the message comprises a media access control (MAC) control element (CE) or downlink control information (DCI).

Example 13 includes the method of Example 12, wherein the MAC CE or the DCI is received from a master cell group (MCG).

Example 14 includes the method of Example 12, wherein the MAC CE or the DCI is from the SCG and relayed via the MCG.

Example 15 includes the method of Example 1, further comprising processing a message from the wireless network to determine whether the SCG is to be activated or kept inactivated when the UE transitions from a radio resource control (RRC) INACTIVE mode to an RRC CONNECTED mode, wherein the message further includes one or more available PSCell actions based on an SCG deactivation configuration.

Example 16 includes the method of Example 15, wherein the message comprises an RRC resume (RRCResume) message indicating that the SCG is to be kept in the SCG deactivated state upon resumption of the RRC CONNECTED mode.

Example 17 includes the method of Example 15, wherein the SCG deactivation configuration includes secondary cell (SCell) information to indicate which of a plurality of SCells of the SCG are to be in a new state where the wireless network expects SCell feedback while the SCG is in the SCG deactivated state.

Example 18 includes the method of Example 17, wherein the SCell feedback comprises at least one of sounding reference signal (SRS) transmissions on the SCell, channel state information (CSI) feedback of the SCell on the PSCell, and CSI feedback of the SCell to transfer PSCell feedback.

Example 19 includes the method of Example 17, wherein the SCG is in a long term evolution (LTE) network, and wherein the SCell information further indicates which of the plurality of SCells of the SCG are to be kept in a dormancy state.

Example 20 includes the method of Example 15, further comprising, in the transition from the RRC INACTIVE mode to the RRC CONNECTED mode, sending a user preference request to the wireless network to indicate at least one of a saved SCG configuration, a preference to deactivate the SCG at resumption of the RRC CONNECTED mode, and a preference to activate the SCG at resumption of the RCC CONNECTED mode.

Example 21 includes the method of Example 20, wherein the user preference request is in an RRC resume (RRCResume) message.

Example 22 includes the method of Example 20, wherein the SCG is in a long term evolution (LTE) network, and wherein the user preference request is in an RRC connection resume (RRCConnectionResume) message.

Example 23 includes the method of Example 1, further comprising, while the UE is in a radio resource control (RRC) CONNECTED state, sending a request to the wireless network to move to the SCG deactivation state.

Example 24 includes the method of Example 23, wherein the request comprises one of: a UE assistance information message sent to a primary cell (Pcell) or another cell of a master cell group (MCG); the UE assistance information message sent to the PSCell or another cell of the SCG using transparent forwarding via the MCG; a message sent via signaling radio bearer 3 (SRB3) to the PSCell or another cell of the SCG; or a media access control (MAC) control element (CE) to the MCG or to the SCG.

Example 25 includes the method of Example 23, further comprising waiting a predetermined period of time before repeating the request.

Example 26 includes the method of Example 1, wherein the SCG is in a long term evolution (LTE) network and a master cell group (MCG) is in either the LTE network or a new radio (NR) network, the method further comprising sending an LTE UE assistance information radio resource control (RRC) message to indicate a request for SCG activation or deactivation.

Example 27 includes the method of Example 26, further comprising processing a timer that prohibits the UE from repeating the request until the timer expires.

Example 28 is a user equipment, comprising means for processing each of the steps in any of the Example 1 to the Example 27.

Example 29 is a computer-readable medium on which computer-executable instructions are stored to implement a method in a wireless network comprising: providing, to a user equipment (UE), bandwidth part (BWP) configurations for a carrier of a primary secondary cell (PSCell) of a secondary cell group (SCG) for dual connectivity (DC); and moving the UE between an SCG activation state and an SCG deactivation state based on the BWP configurations.

Example 30 includes the computer-readable medium of Example 29, wherein a first BWP of the PSCell of the SCG comprises an SCG deactivated configuration, the method wherein the instructions further configure the computer to: generating a first message to the UE to switch from a second BWP of the PSCell of the SCG to the first BWP to move the UE from the SCG activation state to the SCG deactivation state; and generating a second message to the UE to switch from the first BWP to the second BWP to move the UE from the SCG deactivation state to the SCG activation state.

Example 31 includes the computer-readable medium of Example 30, wherein the first message and the second message comprise radio resource control (RRC) signaling.

Example 32 includes the computer-readable medium of Example 30, wherein the first BWP comprising the SCG deactivated configuration is associated with a BWP identifier (ID), and wherein the first message and the second message comprise a media access control (MAC) control element (CE) or downlink control information (DCI).

Example 33 includes the computer-readable medium of Example 30, wherein the instructions further configure the computer to configuring a third BWP of a secondary cell (SCell) of the SCG for operation in the SCG deactivation state.

Example 34 includes the computer-readable medium of Example 29, wherein the instructions further configure the computer to sending a message to the UE that the BWP configurations for the carrier of the PSCell are associated with the SCG deactivation state, wherein the BWP configurations indicate at least one of periodicities and uplink resources for periodic reporting of channel state information (SCI) or sounding reference signal (SRS) transmission.

Example 35 includes the computer-readable medium of Example 34, wherein the message comprises radio resource control (RRC) signaling.

Example 36 includes the computer-readable medium of Example 34, wherein the message comprises a media access control (MAC) control element (CE) or downlink control information (DCI).

Example 37 includes the computer-readable medium of Example 36, wherein the MAC CE or the DCI is received from a master cell group (MCG).

Example 38 includes the computer-readable medium of Example 36, wherein the MAC CE or the DCI is from the SCG and relayed via the MCG.

Example 39 includes the computer-readable medium of Example 29, wherein the instructions further configure the computer to sending a message to the UE to indicate whether the SCG is to be activated or kept inactivated when the UE transitions from a radio resource control (RRC) INACTIVE mode to an RRC CONNECTED mode, wherein the message further includes one or more available PSCell actions based on an SCG deactivation configuration.

Example 40 includes the computer-readable medium of Example 39, wherein the message comprises an RRC resume (RRCResume) message indicating that the SCG is to be kept in the SCG deactivated state upon resumption of the RRC CONNECTED mode.

Example 41 includes the computer-readable medium of Example 39, wherein the SCG deactivation configuration includes secondary cell (SCell) information to indicate which of a plurality of SCells of the SCG are to be in a new state for SCell feedback while the SCG is in the SCG deactivated state.

Example 42 includes the computer-readable medium of Example 41, wherein the SCell feedback comprises at least one of sounding reference signal (SRS) transmissions on the SCell, channel state information (CSI) feedback of the SCell on the PSCell, and CSI feedback of the SCell to transfer PSCell feedback.

Example 43 includes the computer-readable medium of Example 41, wherein the SCG is in a long term evolution (LTE) network, and wherein the SCell information further indicates which of the plurality of SCells of the SCG are to be kept in a dormancy state.

Example 44 includes the computer-readable medium of Example 39, wherein the instructions further configure the computer to, receiving from the UE in the transition from the RRC INACTIVE mode to the RRC CONNECTED mode, a user preference request to that indicates at least one of a saved SCG configuration, a preference to deactivate the SCG at resumption of the RRC CONNECTED mode, and a preference to activate the SCG at resumption of the RCC CONNECTED mode.

Example 45 includes the computer-readable medium of Example 44, wherein the user preference request is in an RRC resume (RRCResume) message.

Example 46 includes the computer-readable medium of Example 44, wherein the SCG is in a long term evolution (LTE) network, and wherein the user preference request is in an RRC connection resume (RRCConnectionResume) message.

Example 47 includes the computer-readable medium of Example 29, wherein the instructions further configure the computer to, while the UE is in a radio resource control (RRC) CONNECTED state, receiving a request from the UE to move to the SCG deactivation state.

Example 48 includes the computer-readable medium of Example 47, wherein the request comprises one of: a UE assistance information message sent to a primary cell (Pcell) or another cell of a master cell group (MCG); the UE assistance information message sent to the PSCell or another cell of the SCG using transparent forwarding via the MCG; a message sent via signaling radio bearer 3 (SRB3) to the PSCell or another cell of the SCG; or a media access control (MAC) control element (CE) to the MCG or to the SCG.

Example 49 includes the computer-readable medium of Example 29, wherein the SCG is in a long term evolution (LTE) network and a master cell group (MCG) is in either the LTE network or a new radio (NR) network, the method wherein the instructions further configure the computer to receiving, from the UE, an LTE UE assistance information radio resource control (RRC) message indicating a request for SCG activation or deactivation.

Example 50 may include an apparatus comprising means to perform one or more elements of a method described in or related to any of the above Examples, or any other method or process described herein.

Example 51 may include one or more non-transitory computer-readable media comprising instructions to cause an electronic device, upon execution of the instructions by one or more processors of the electronic device, to perform one or more elements of a method described in or related to any of the above Examples, or any other method or process described herein.

Example 52 may include an apparatus comprising logic, modules, or circuitry to perform one or more elements of a method described in or related to any of the above Examples, or any other method or process described herein.

Example 53 may include a method, technique, or process as described in or related to any of the above Examples, or portions or parts thereof.

Example 54 may include an apparatus comprising: one or more processors and one or more computer-readable media comprising instructions that, when executed by the one or more processors, cause the one or more processors to perform the method, techniques, or process as described in or related to any of the above Examples, or portions thereof.

Example 55 may include a signal as described in or related to any of the above Examples, or portions or parts thereof.

Example 56 may include a datagram, packet, frame, segment, protocol data unit (PDU), or message as described in or related to any of the above Examples, or portions or parts thereof, or otherwise described in the present disclosure.

Example 57 may include a signal encoded with data as described in or related to any of the above Examples, or portions or parts thereof, or otherwise described in the present disclosure.

Example 58 may include a signal encoded with a datagram, packet, frame, segment, PDU, or message as described in or related to any of the above Examples, or portions or parts thereof, or otherwise described in the present disclosure.

Example 59 may include an electromagnetic signal carrying computer-readable instructions, wherein execution of the computer-readable instructions by one or more processors is to cause the one or more processors to perform the method, techniques, or process as described in or related to any of the above Examples, or portions thereof.

Example 60 may include a computer program comprising instructions, wherein execution of the program by a processing element is to cause the processing element to carry out the method, techniques, or process as described in or related to any of the above Examples, or portions thereof.

Example 61 may include a signal in a wireless network as shown and described herein.

Example 13C may include a method of communicating in a wireless network as shown and described herein.

Example 62 may include a system for providing wireless communication as shown and described herein.

Example 63 may include a device for providing wireless communication as shown and described herein.

Any of the above described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE) in a wireless network, the method comprising:
determining bandwidth part (BWP) configurations for a carrier of a primary secondary cell (PSCell) of a secondary cell group (SCG) for dual connectivity (DC); and
moving between an SCG activation state and an SCG deactivation state based on the BWP configurations.

2. The method of claim 1, further comprising:
identifying that a first BWP of the PSCell of the SCG comprises an SCG deactivated configuration;
in response to a first message from the wireless network to switch from a second BWP of the PSCell of the SCG to the first BWP, moving from the SCG activation state to the SCG deactivation state; and
in response to a second message from the wireless network to switch from the first BWP to the second BWP, moving from the SCG deactivation state to the SCG activation state.

3. The method of claim 2, wherein the first message and the second message comprise radio resource control (RRC) signaling.

4. The method of claim 2, wherein the first BWP comprising the SCG deactivated configuration is associated with a BWP identifier (ID), and wherein the first message and the second message comprise a media access control (MAC) control element (CE) or downlink control information (DCI).

5. The method of claim 4, wherein the MAC CE or the DCI is received from a master cell group (MCG).

6. The method of claim 4, wherein the MAC CE or the DCI is from the SCG and relayed via the MCG.

7. The method of claim 2, further comprising:
identifying that a secondary cell (SCell) of the SCG is configured with a third BWP for operation in the SCG deactivation state; and
determining, from the SCG deactivated configuration of the first BWP of the PSCell, at least one of periodicities and uplink resources for periodic reporting of channel state information (SCI) or sounding reference signal (SRS) transmission.

8. The method of claim 7, further comprising:
receiving an indication from the wireless network to use a dormant BWP configuration for the SCell in the SCG deactivation state;
if the third BWP is not configured, using the BWP configuration for operation of the SCell in the SCG deactivation state; and
if neither the third BWP nor the dormant BWP configuration is configured, consider the SCell to be deactivated.

9. The method of claim 1, further comprising:
determining, based on a message from the wireless network, that the BWP configurations for the carrier of the PSCell are associated with the SCG deactivation state;
moving the UE to the SCG deactivation state for the SCG; and
performing one or more SCG deactivated actions irrespective of a particular BWP currently used by the UE.

10. The method of claim 9, further comprising determining, from the BWP configurations, at least one of periodicities and uplink resources for periodic reporting of channel state information (SCI) or sounding reference signal (SRS) transmission.

11. The method of claim 9, wherein the message comprises radio resource control (RRC) signaling.

12. The method of claim 9, wherein the message comprises a media access control (MAC) control element (CE) or downlink control information (DCI).

13. The method of claim 12, wherein the MAC CE or the DCI is received from a master cell group (MCG).

14. The method of claim 12, wherein the MAC CE or the DCI is from the SCG and relayed via the MCG.

15. The method of claim 1, further comprising processing a message from the wireless network to determine whether the SCG is to be activated or kept inactivated when the UE transitions from a radio resource control (RRC) INACTIVE mode to an RRC CONNECTED mode, wherein the message further includes one or more available PSCell actions based on an SCG deactivation configuration.

16. The method of claim 15, wherein the message comprises an RRC resume (RRCResume) message indicating that the SCG is to be kept in the SCG deactivated state upon resumption of the RRC CONNECTED mode.

17. The method of claim 15, wherein the SCG deactivation configuration includes secondary cell (SCell) information to indicate which of a plurality of SCells of the SCG are to be in a new state where the wireless network expects SCell feedback while the SCG is in the SCG deactivated state.

18. The method of claim 17, wherein the SCell feedback comprises at least one of sounding reference signal (SRS) transmissions on the SCell, channel state information (CSI) feedback of the SCell on the PSCell, and CSI feedback of the SCell to transfer PSCell feedback.

19. The method of claim 17, wherein the SCG is in a long term evolution (LTE) network, and wherein the SCell information further indicates which of the plurality of SCells of the SCG are to be kept in a dormancy state.

20-28. (canceled)

29. A computer-readable medium on which computer-executable instructions are stored to implement a method in a wireless network comprising:
providing, to a user equipment (UE), bandwidth part (BWP) configurations for a carrier of a primary secondary cell (PSCell) of a secondary cell group (SCG) for dual connectivity (DC); and
moving the UE between an SCG activation state and an SCG deactivation state based on the BWP configurations.

30-49. (canceled)
